(19) United States
(12) Patent Application Publication
(10) Pub. No.: US 2018/0364603 A1
(43) Pub. Date: Dec. 20, 2018

(54) INTERMEDIATE TRANSFER MEMBER, METHOD FOR PRODUCING THE SAME, AND IMAGE FORMING APPARATUS

(71) Applicant: Konica Minolta, Inc., Tokyo (JP)

(72) Inventors: Teruo SASAKI, Tokyo (JP); Akihiro HONYA, Tokyo (JP); Kazunori KURIMOTO, Tokyo (JP)

(21) Appl. No.: 16/000,379

(22) Filed: Jun. 5, 2018

(30) Foreign Application Priority Data
Jun. 14, 2017 (JP) 2017-116724

(51) Int. Cl. G03G 15/01; G03G 15/16

(52) U.S. Cl. CPC G03G 15/0136; G03G 15/1605

(57) ABSTRACT

The intermediate transfer member of the present invention has a substrate layer made of a resin and a surface layer disposed on the substrate layer. The surface layer is an integrated matter made of a polymer of a polyfunctional monomer and contains a black titanium compound dispersed in the surface layer. A method for producing the same comprises irradiating a coating film of a coating containing a black titanium oxide and the monomer with a high energy light beam to polymerize the monomer to thereby fabricate the surface layer. The image forming apparatus of the present invention has the intermediate transfer member.

### CROSS REFERENCE TO RELATED APPLICATIONS

The entire disclosure of Japanese Patent Application No. 2017-116724 filed on Jun. 14, 2017, is incorporated herein by reference in its entirety.

### BACKGROUND

### Technological Field

The present invention relates to an intermediate transfer member, a method for producing the same, and an image forming apparatus including the intermediate transfer member.

### Description of Related Art

In an electrophotographic image forming apparatus, for example, a latent image formed on a photoconductor is developed with a toner, the toner image thus obtained is temporarily carried on an endless belt type intermediate transfer member, and the toner image carried on the intermediate transfer member is transferred onto a recording medium such as paper.

Among such intermediate transfer members, there is known an intermediate transfer member having an integrated surface layer made of an acryl resin formed by polymerizing monomers constituting a coating film in order to improve its durability (e.g., Japanese Patent Literature Laid-Open No. 2016-194666). Among intermediate transfer members as described above, there is known an endless intermediate transfer belt having a surface layer produced by heating and solidifying a coating film of a resin solution containing titanium black dispersed therein (e.g., Japanese Patent Literature Laid-Open No. H11-268147). Among intermediate transfer members as described above, there is also known an endless intermediate transfer belt having a surface layer containing titanium oxynitride dispersed therein (e.g., Japanese Patent Literature Laid-Open No. 2017-40871).

### SUMMARY

Incidentally, in the case where the electrophotographic image forming apparatus described above is used in printing industries, higher performance is required with respect to various properties such as image quality and the durability of the apparatus. Thus, the properties required from the intermediate transfer member are required to be further improved, depending on use forms of the image forming apparatus.

Under such circumstances, conventional intermediate transfer members may have insufficient durability, possibly will have insufficient durability depending on the environment, or may provide lower image quality in association with long-term use. For example, the intermediate transfer member described in PLT 2 may have insufficient durability. The intermediate transfer member described in PLT 1 possibly will have insufficient durability depending on the environment. For example, an image having sufficient image quality may be formed in the early use stage of the image forming apparatus, but the image quality may become insufficient when the apparatus is used for a long period in a high temperature and high humidity environment.

In the intermediate transfer member described in PLT 3, an improvement in the image quality and an improvement in the mechanical durability have been carried out by additional use of titanium oxynitride. Unfortunately, the intermediate transfer member has at least two problems as follows.

The first problem is that presence of titanium oxynitride may reduce the generation rate of photoradicals derived from the polymerization initiator and the reaction rate is likely to decrease. That is, titanium oxynitrides have a particularly large extinction coefficient with respect to both ultraviolet light and visible light. Even when blended in a blend ratio by weight of about 10 to 30% in a thickness of several micrometers, titanium oxynitrides usually exhibit light absorption high enough to substantially prevent transmission of any light irrespective of ultraviolet light and visible light. Accordingly, when a common polymerization initiator such as IRGACURE 184 (manufactured by BASF SE, “IRGACURE” is a registered trademark of the company) is used, there may be a problem of a decrease in the generation rate of photoradicals derived from the polymerization initiator due to presence of titanium oxynitride, and the reaction rate is likely to decrease.

The second problem is that, in the case of a film thickness of several micrometers or less, photoradicals derived from the polymerization initiator are influenced by oxygen inhibition, and thereby the reaction rate is likely to decrease.

Because of such a decrease in the reaction rate, polymerizable sites of the resin monomers constituting the surface layer become likely to remain as they are. In this case, the polymerizable sites in the monomers are degraded by discharge products (e.g., ozone and the like) produced from energization in use of the intermediate transfer member to change into oxides having a carbonyl group or the like. This may cause a change in the electrical resistance, and the image quality may become insufficient in a long-term use. As aforementioned, conventional intermediate transfer members are susceptible to consideration from the viewpoint of suppressing a decrease in the image quality due to continuous use in the case where energization and mechanical driving are combined and suppressing their environmental dependence.

A first object of the present invention is to provide an intermediate transfer member capable of forming high quality images electrophotographically over a long period irrespective of the environment.

A second object of the present invention is to provide an image forming apparatus capable of forming high quality images electrophotographically over a long period irrespective of the environment.

According to an aspect of the present invention to solve the first object, there is provided an intermediate transfer member including a substrate layer made of a resin, and a surface layer disposed on the substrate layer, in which the surface layer is an integrated matter made of a polymer of a polyfunctional monomer and comprises a black titanium compound dispersed in the surface layer and at least one component selected from the group consisting of an oxime ester polymerization initiator, an acylphosphine oxide polymerization initiator, and residues of these polymerization initiators.

According to another aspect of the present invention to solve the first object, there is provided a method for producing the intermediate transfer member including polymerizing the polyfunctional monomer in a coating film of a coating containing the monomer and the black titanium compound on the substrate layer made of the resin to fabricate the surface layer on the substrate layer, in which the coating comprises one or both of an oxime ester polymerization initiator and an acylphosphine oxide polymerization initiator, and the coating film is irradiated with a high energy light beam that provides energy for polymerizing the monomer to thereby polymerize the monomer.

Furthermore, the present invention provides an electrophotographic image forming apparatus having the intermediate transfer member described above, as a measure to solve the aforementioned second object.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates the configuration of an image forming apparatus according to one embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

An intermediate transfer member according to one embodiment of the present invention has a substrate layer made of a resin, and a surface layer disposed on the substrate layer described above. The form of the intermediate transfer member may be appropriately determined in a range in which predetermined functions develop. For example, the intermediate transfer member may be a cylindrical intermediate transfer drum or an endless belt type intermediate transfer belt. The intermediate transfer member is preferably the intermediate transfer belt described above from the viewpoint of saving the space for the imaging section in the image forming apparatus.

The resin constituting the substrate layer described above can be appropriately selected from resins that are not modified and deformed in the use temperature range of the intermediate transfer member. Examples of such resins include polycarbonates, polyphenylenesulfides (PPS), polyvinylidene fluoride, polyimides (PI), polyamideimides (PAI), polyalkylene terephthalates, polyethers, polyether ketones, polyether ether ketones, ethylene-tetrafluoroethylene copolymers, and polyamides. Examples of the polyalkylene terephthalate described above include polyethylene terephthalate and polybutylene terephthalate.

The resin is preferably a polyimide, polycarbonate, polyphenylenesulfide, polyamideimide, or polyalkylene terephthalate, more preferably a polyphenylenesulfide, polyimide, or polyamideimide, from the viewpoint of the durability.

The substrate layer preferably has an electrical resistance value, as a volume resistivity, of 10⁵ to 10¹¹ Ω·cm, from the viewpoint of optimization of conditions for transfer of a toner image from the photoconductor to the intermediate transfer member and conditions for transfer of the toner image from the intermediate transfer member to a next medium and optimization of the concentration of the toner image. The electrical resistance value can be measured by a known method, for example, and can be adjusted by addition of an electrically conductive substance, for example, to the substrate layer.

An example of the electrically conductive substance includes carbon black. The carbon black may be neutral carbon black or may be acidic carbon black. The content of the electrically conductive substance in the substrate layer may be appropriately determined in a range in which the predetermined electrical resistance value described above is achieved, and is preferably 10 to 20 parts by mass, more preferably 10 to 16 parts by mass based on 100 parts by mass of the resin.

When the thickness of the substrate layer is excessively small, its strength and durability may become insufficient. When the thickness is excessively large, strain accumulation caused by sequential application of expansion, contraction, and bending stress due to temperature change may lead to cracking. The thickness of the substrate layer is preferably 50 to 200 μm from the viewpoint of achievement of the strength and mechanical durability of the intermediate transfer member and prevention of cracking caused by a series of deformation and bending stress due to temperature change.

The substrate layer may further contain other components besides the resin described above in the range where the effect of the present embodiment can be achieved. One or two or more of the other components may be contained, and examples thereof include the electrically conductive substances described above and a dispersant such as nylon compound.

The substrate layer can be produced by a known method. For example, the substrate layer can be produced by melting and kneading the resin described above on an extruder, extruding the resin through an annular die, and slicing the cylindrical substrate layer produced. Such a method for producing a substrate layer is advantageous when the resin is PPS or soluble polyimide. The substrate layer also can be produced by coating a coating for substrate layer onto the outer peripheral surface of a cylindrical substrate and solidifying the coated film formed. Such a method for producing a substrate layer is effective when the resin is PI or PAI.

Polyimide can be obtained by heating polyamic acid, which is a precursor thereof. Polyamic acid can be obtained by allowing a tetracarboxylic dianhydride to react with a diamine each in equimolar amounts. The content of polyimide in the substrate layer is 51 mass % or more, for example.

The surface layer is an integrated matter made of a polymer of a polyfunctional monomer. “Polyfunctional” means having two or more polymerizable functional groups per molecule of the monomer described above. One or more types of the monomers may be used. The number of the functional groups described above is preferably 2 or more, more preferably 4 or more, from the viewpoint of construction of a three-dimensional crosslinked structure in the surface layer and an improvement in the durability thereby. The monomers are preferably compounds that polymerize by irradiation of a high-energy light beam described below such as light and electron beams, from the viewpoint of suppressing thermal degradation of a black titanium compound in a production process. Examples of the monomers include (meth)acrylic acid compounds.

The (meth)acrylic acid compound is a generic name of acrylic acid compounds and methacrylic acid compounds, and means one or both of these. The (meth)acrylic acid compound has two or more (meth)acryloyl groups per molecule. The (meth)acryloyl group is a generic name of acryloyl groups and methacryloyl groups, and means one or both of these. Examples of the (meth)acrylic acid compounds include ethylene oxide-modified pentaerythritol tetra(meth)acrylate, propylene oxide-modified pentaerythritol tetra(meth)acrylate, ethylene oxide-modified dipentaerythritol hexa(meth)acrylate, ethylene oxide-modified dipentaerythritol penta(meth)acrylate, propylene oxide-modified dipentaerythritol hexa(meth)acrylate, propylene oxide-modified dipentaerythritol penta(meth)acrylate, ε-caprolactone-modified dipentaerythritol hexa(meth)acrylate, ε-caprolactone-modified dipentaerythritol penta(meth)acrylate, ethylene oxide-modified trimethylolpropane tri(meth)acrylate, propylene oxide-modified trimethylolpropane tri(meth)acrylate, ethylene oxide-modified bisphenol A di(meth)acrylate, propylene oxide-modified bisphenol A di(meth)acrylate, dimethylol-tricyclodecane di(meth)acrylate, diethylene glycol di(meth)acrylate, dipropylene glycol di(meth)acrylate, triethylene glycol di(meth)acrylate, tripropylene glycol di(meth)acrylate, polyethylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, and neopentyl glycol di(meth)acrylate.

The surface layer contains a black titanium compound dispersed therein. The black titanium compound is a less than tetravalent titanium compound. This titanium compound exhibits black or a deep color close to black. One or more black titanium compounds as described above may be contained, and examples thereof include trivalent titaniums and lower order titanium oxides.

The trivalent titaniums described above are compounds containing titanium having a valence of 3, and examples thereof include oxides such as Ti₂O₃ and salts such as TiCl₃. From the viewpoint of the stability at normal temperature and in a general atmosphere, the trivalent titanium is preferably an oxide such as Ti₂O₃.

The lower order titanium oxides described above are titanium oxide compounds having a valence less than 4, including oxides of trivalent titanium aforementioned. Examples of the lower order titanium oxide include titanium compounds having a composition of TiO, Ti₂O₃, Ti₃O₅, and Ti₄O₇, or TinO₂ₙ₋₁. The lower order titanium oxide may be constituted as a composition of several types of titanium oxides. For example, “Ti₂O₃” may be a composition containing equimolar amounts of TiO₂ and TiO, and “Ti₃O₅” may be a composition containing equimolar amounts of TiO₂ and Ti₂O₃ or a composition containing 2 molar equivalents of TiO₂ and 1 molar equivalent of TiO. The lower order titanium oxide may contain a tetravalent titanium compound in the range where the total valence is less than 4.

The black titanium compound, when containing a nitrogen atom, tends to strongly absorb light having a wavelength in the ultraviolet region and the vicinity thereof. As a result, the polymerizable sites of the monomers aforementioned are likely to remain, or a larger amount of the polymerization initiator may be required. From such a viewpoint, the content of the nitrogen atom in the black titanium compound is preferably low, and the black titanium compound more preferably contains no nitrogen atom. The nitrogen atom in a black titanium compound may be entrained, for example, in association with production of the black titanium compound (for example, production in which ammonia is employed as a reducing agent).

The black titanium compound described above may be produced by carrying out a known method, for example, a method of reducing a titanium oxide using a variety of reducing agents (such as hydrogen, ammonia, carbon black, and metal titanium), or a synthesis method by means of microwaves described in NPL “Synthesis of Ti₄O₇ Nanoparticles by Carbothermal Reduction Using Microwave Rapid Heating (Catalysts 2017, 7, 65-)”, or can be available as a commercially available product. Examples of the commercially available product include “Titanium Black” (manufactured by Mitsubishi Materials Electronic Chemicals Co., Ltd.) and “Tilack D” (manufactured by AKO KASEI CO., LTD., a registered trademark of the company).

Since the black titanium compound exhibits black or a deep color as aforementioned, it is possible to check if the compound has the predetermined performance from its blackness degree. The blackness degree of the black titanium compound, as an L value, is preferably 40 or less, more preferably 7 to 22, particularly preferably 8 to 16. When the blackness degree is excessively low, that is, the L value is excessively large, the electrical resistance of the black titanium compound excessively increases, and thus, the image quality becomes insufficient in continuous use. Alternatively, when the blackness degree is high, that is, the L value is small, in the case where polymerization of the surface layer is carried out with irradiation of ultraviolet radiation, the polymerization may be unlikely to occur.

In synthesis of a black titanium compound by reduction of TiO₂, when reduction including oxides of less than tetravalent titanium ions such as Ti₈O₁₅, Ti₅O₉, Ti₄O₇, Ti₃O₅, and Ti₂O₃ is carried out, it is obvious that the coloration becomes stronger to exhibit black or a deep color. The L value in this case is usually 8 to 16, and the resistivity of the powder is usually 0.1 to 3,000 Ωcm.

However, in the case where the reduction is allowed to further proceed to TiO, the color of the material no longer deepens, and the L value rather increases to generally 9 to 22. The resistivity of the powder at this time is 0.001 to 0.1.

As aforementioned, the L value does not become smaller without limitation depending on the degree of reduction, and thus, it is particularly difficult to set the L value to 7 or less.

The electrical resistance can be lowered by increasing the degree of reduction. When a black titanium compound having low resistance is used, a design that satisfies the resistance conditions for a transfer belt is enabled by lowering the blend ratio by volume of the black titanium compound in the substrate layer. Unfortunately, when the blend ratio by volume is small, unevenness in blending is likely to be notable, and if such unevenness in blending occurs, unevenness in the electrical resistance may be caused, and thus, image defects (density unevenness) may be caused by occurrence of unevenness in the transfer current. That is, designing the production conditions to prevent image defects becomes difficult. In the case of a design in which the blend ratio by volume is increased to accept a certain decrease in the electrical resistance, toner charging becomes difficult to maintain, and problems such as a decrease in the image density may occur.

For the reasons described above, in consideration of achieving both the design of the electrical resistance and the design of the production conditions, a design in which a black titanium compound having a moderate resistivity is blended in a blend ratio by volume of 1% or more is desirable. For satisfying this, the L value described above is generally 8 to 16, and the resistivity of the black titanium compound powder is generally 0.1 to 3,000 Ωcm.

The L value can be determined by coating a portion of sample plate with a powder to be detected and measuring the lightness of the coated portion with a spectrophotometer. The L value also can be increased or decreased by further reducing or heating the black titanium compound.

As for the black titanium compound described above, if in a powder state, a peak derived from Ti³⁺ and the like can be detected by means of X-ray high potential spectroscopy (ESCA, XPS). Alternatively, if in the case of TinO₂ₙ₋₁ (n=3 to 9), a crystal pattern derived from a lower order titanium oxide having a magneli phase is known, and thus, detection is enabled by carrying out by X ray diffraction analysis. Likewise, Ti³⁺ and the like can be detected also by X-ray absorption fine structure analysis (XAFS).

A black titanium compound is oxidized by heating to be modified into a white titanium oxide. Thus, when thermogravimetric analysis (TG) is carried out, an increase in the weight by oxidation of the black titanium compound into a white titanium oxide is detected as well as the change in the color from black to white is confirmed. Also by such a method, it is possible to confirm that the powder in the surface layer is a black titanium compound.

The black titanium compound can be removed from the surface layer by a known method including removal of only a filler made of an inorganic metal oxide from the surface layer made of an acryl resin, for example, a method including removal of the filler from the surface layer by decomposing the resin constituting the surface layer using an acidic or basic catalyst.

A black titanium compound, when subjected to a certain degree of heat, for example heat at more than 300° C. or irradiated with laser light having a wavelength in the visible to near-infrared regions (e.g., YAG laser), is oxidized and modified into a white titanium oxide. Thus, when containing a Ti element is obvious, a simple method such as described above can be used to check if the Ti element is present or not. The presence of a titanium element can be confirmed by dissolving all of the filler in the surface layer in a solution of a fluorine-containing acid and analyzing the solution thus obtained by high-frequency inductively coupled plasma emission spectroscopy (ICP), for example.

The particle size of the black titanium compound, as the number average particle size, is preferably 5 to 300 nm, from the viewpoint of an improvement of the dispersibility of the black titanium compound in the surface layer, more preferably 20 to 200 nm. When the particle size is excessively large, the black titanium compound becomes likely to sediment in a coating material for surface layer or its coating film. When the particle size is excessively small, particularly in the case where surface treatment is applied, insufficient dispersion may occur by local inhomogeneity and defects of the surface treatment, for example, the black titanium compound lacking surface treatment may sediment. In either of the cases, the dispersibility may become insufficient.

The black titanium compound has been preferably surface-treated. The surface treatment of the black titanium compound is preferably a treatment including allowing a surface treating agent to act directly on the surface of the black titanium compound to bind organic functional groups thereto, from the viewpoints of suppressing modification in manufacture of the surface layer, an improvement in the dispersibility, and an improvement in the image quality. The surface treating agent described above is preferably a silane coupling agent, from the viewpoint of suppressing thermal modification of the black titanium compound during surface treatment. The organic functional group described above is preferably a (meth)acryloyl group, from the viewpoints of improving the mechanical strength of the surface layer and suppressing the migration of the black titanium compound in the surface layer to maintain or improve the electrical properties. From the above viewpoints, for example, the black titanium compound in the surface layer preferably has either one or both of a (meth)acryloyl group and the residue thereof on the surface of the black titanium compound.

The silane coupling agent having a (meth)acryloyl group, as the surface treating agent, include compounds represented by the following S-1 to S-33.

CH₂═CHSi(CH₃)(OCH₃)₂ S-1

CH₂═CHSi(OCH₃)₃ S-2

CH₂═CHSiCl₃ S-3

CH₂═CHCOO(CH₂)₂Si(CH₃)(OCH₃)₂ S-4

CH₂═CHCOO(CH₂)₂Si(OCH₃)₃ S-5

CH₂═CHCOO(CH₂)₂Si(OC₂H₅)(OCH₃)₂ S-6

CH₂═CHCOO(CH₂)₃Si(OCH₃)₃ S-7

CH₂═CHCOO(CH₂)₂Si(CH₃)Cl₂ S-8

CH₂═CHCOO(CH₂)₂SiCl₃ S-9

CH₂═CHCOO(CH₂)₃Si(CH₃)Cl₂ S-10

CH₂═CHCOO(CH₂)₃SiCl₃ S-11

CH₂═C(CH₃)COO(CH₂)₂Si(CH₃)(OCH₃)₂ S-12

CH₂═C(CH₃)COO(CH₂)₂Si(OCH₃)₃ S-13

CH₂═C(CH₃)COO(CH₂)₃Si(CH₃)(OCH₃)₂ S-14

CH₂═C(CH₃)COO(CH₂)₃Si(OCH₃)₃ S-15

CH₂═C(CH₃)COO(CH₂)₂Si(CH₃)Cl₂ S-16

CH₂═C(CH₃)COO(CH₂)₂SiCl₃ S-17

CH₂═C(CH₃)COO(CH₂)₃Si(CH₃)Cl₂ S-18

CH₂═C(CH₃)COO(CH₂)₃SiCl₃ S-19

CH₂═CHSi(C₂H₅)(OCH₃)₂ S-20

CH₂═C(CH₃)Si(OCH₃)₃ S-21

CH₂═C(CH₃)Si(OC₂H₅)₃ S-22

CH₂═CHSi(OC₂H₅)₃ S-23

CH₂═C(CH₃)Si(CH₃)(OCH₃)₂ S-24

CH₂═CHSi(CH₃)Cl₂ S-25

CH₂═CHCOOSi(OCH₃)₃ S-26

CH₂═CHCOOSi(OC₂H₅)₃ S-27

CH₂═C(CH₃)COOSi(OCH₃)₃ S-28

CH₂═C(CH₃)COOSi(OC₂H₅)₃ S-29

CH₂═C(CH₃)COO(CH₂)₃Si(OC₂H₅)₃ S-30

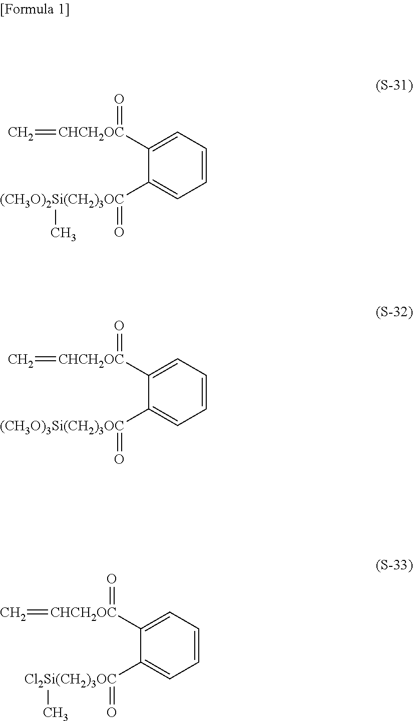

The surface treating agent may be an epoxy compound. Examples of the epoxy compound include compounds represented by the following formulas (S-34) to (S-36).

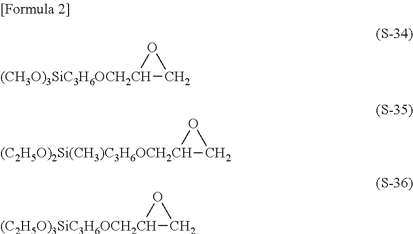

The surface treatment of the black titanium compound can be carried out by a known method. For example, such surface treatment can be carried out by mixing 100 parts by mass of black titanium oxide, 0.1 to 200 parts by mass of a surface treating agent, and 50 to 5,000 parts by mass of a solvent by means of a wet media dispersion type apparatus. Alternatively, the treatment can be carried out by stirring a slurry containing the black titanium compound and a surface treating agent, and then, removing the dispersion medium of the slurry to obtain the black titanium compound. The amount of the surface treating agent in the surface-treated black titanium compound (amount of surface treatment) is preferably 0.1 to 60 mass %, more preferably 5 to 40 mass %.

The surface layer may further contain other components in the range where the effect of the present embodiment can be achieved. The content of the other components in the surface layer can be appropriately determined in the range where both the effect of the present embodiment and the effect of the components thereof can be achieved, and is, for example, about several mass %. Examples of the other components include a filler other than the black titanium compound and an antioxidant. Examples of the filler include conductive particles and white titanium oxide.

The conductive particles described above are, for example, metal oxide particles having an electrical conductivity, and can be appropriately selected from particles that are known to be added to a layer having an electrical conductivity in the constituent members of an image forming apparatus. One or more types of the conductive particles may be used, and examples thereof include indium-tin composite oxide (ITO) particles, tin oxide particles, nanoparticles of white titanium oxide, and zinc oxide particles. Of these, tin oxide particles or nanoparticles of white titanium oxide are preferred.

The white titanium oxide, which is roughly a titanium oxide not included in the black titanium compound described above, is generally white (L value of 70 or more) and having a lower electrical conductivity than that of black titanium compounds, although depending on the particle size and crystal form.

Reduction of the white titanium oxide can make the white titanium oxide the black titanium compound described above. For example, a white titanium oxide having a low degree of reduction generally has a color tone midway between white and black and a slightly higher electrical conductivity, which is about 10^{3.5} to 10⁶ Ωcm as a resistivity, than that of an unreduced white titanium oxide.

A titanium oxide having a larger degree of reduction (e.g., Ti₃O₅, Ti₄O₇ and the like) generally has a black color tone, corresponding to an L value of 7 to 20, and has an electrical conductivity as a resistivity of about 10⁻¹ to 10^{3.5} Ωcm, corresponding to that of the black titanium compound.

A titanium oxide having a still larger degree of reduction (e.g., one having a molar ratio of Ti to an oxygen atom of 1 to 1.5 and the like) generally has a lower blackness degree than that of the titanium oxide having a large degree of reduction described above, corresponding to an L value of about 9 to 22, has an electrical conductivity as a resistivity of 10⁻¹ to 10⁻³ Ωcm, corresponding to that of the black titanium compound described above. In this case, the difference between the blackness degree of this titanium oxide and the blackness degree of the titanium oxide having a larger degree of reduction is a minor difference that is usually difficult to discern.

Both the fillers may be surface-treated with a surface treating agent. The surface treatment can be carried out in the same manner as for the black titanium compound aforementioned.

The conductive particles described above such as nanoparticles of the white titanium oxide have a highly homogeneous electrical conductivity. Thus, local unevenness in the electrical conductivity is unlikely to occur, and thereby image unevenness is unlikely to occur. A function of improving the mechanical strength of the surface layer also develops. The content of a filler (inorganic material) to be optionally blended, such as the conductive particles, is preferably 5 to 40 parts by volume, more preferably 10 to 30 parts by volume based on 100 parts by volume of an inorganic dispersoid in the surface layer. When the content of the organic material is excessively low, the effect of improving the strength of the surface layer may become insufficient and may be responsible for non-uniformity of conductive paths. When the content is excessively high, specific conductive paths due to direct contact of the inorganic material particles with each other is likely to be formed, and, as a result, local image unevenness may occur.

The number average primary particle size of the inorganic material is preferably 1 to 300 nm, more preferably 3 to 100 nm from the viewpoint of improving the abrasion resistance of the surface layer and the viewpoint of improving the dispersibility of the inorganic material in the surface layer.

The components contained in the surface layer can be identified and quantified by a known method. For example, an organic component can be analyzed by pyrolysis GC-MS or by GC-MS of a hydrolysate obtained after ester bonds are hydrolyzed. In such analyses, a comparison with the analysis result of a standard cured product also can be used. Examples of the components contained in the surface layer include the materials of the surface layer, reactants thereof (polyfunctional monomers and the like), reaction assisting components therefor (a polymerization initiator and the like), and residues thereof.

The particle size of the particles in the surface layer also can be determined by a known method. For example, their number average primary particle size can be calculated by taking a photograph under magnification of 10,000 by a scanning electron microscope (JEOL Ltd.), randomly capturing 300 particles other than aggregated particles by a scanner, and analyzing the photo image obtained using automatic image processing and analyzing apparatus (LUZEX AP; NIRECO CORPORATION) software Version. 1.32. The particle size can be adjusted by classification of these particles or mixing of classified products.

When the content of the black titanium compound in the surface layer is excessively low, the properties of other components (e.g., the filler and the like) may be more strongly exhibited to lower the effect of the present embodiment, or the electrical conductivity may become inhomogeneous locally to result in image defects. When the content is excessively high, the conditions for forming the surface layer by ultraviolet irradiation may become severer. From such a viewpoint, the content described above is preferably 2 to 90 parts by volume, more preferably 5 to 60 parts by volume based on 100 parts by volume of the inorganic material in the surface layer.

When the thickness of the surface layer is excessively small, the homogeneity of the composition of the surface layer may become insufficient. From such a viewpoint, the thickness of the surface layer is preferably five times or more the particle size of the black titanium compound and other fillers in the surface layer, more preferably 10 times or more.

In contrast, when the thickness of the surface layer is excessively small, the mechanical strength of the surface layer may become insufficient to lead to its insufficient durability. Alternatively, polymerization reaction of polyfunctional monomers may proceed insufficiently to cause polymerizable functional groups to remain in the surface layer, and thus, deterioration over time by discharge products and the like becomes likely to occur. From such a viewpoint, the thickness is preferably, for example, 0.5 μm or more, more preferably 0.8 μm or more, still more preferably 1.0 μm or more.

When the thickness of the surface layer is excessively large, an increase in the extinction coefficient caused by containing the black titanium compound may make curing in the vicinity of the substrate interface difficult to lower the strength of the film. Additionally, the effect of durability may plateau. From such a viewpoint, the thickness is preferably 10 μm or less.

The intermediate transfer member may have a configuration in which the surface layer is disposed directly on the substrate layer. In the range where the effect of the present embodiment can be achieved, the intermediate transfer member may further have another constituent. For example, the intermediate transfer member may further have an elastic layer between the substrate layer and the surface layer for the purpose of improving the transferability. Having such an elastic layer is advantageous from the viewpoint of improving the transferability in the secondary transfer onto various recording media including rough paper and may further enhance the value of the intermediate transfer member.

The intermediate transfer member can be produced by a known method. For example, the intermediate transfer member can be produced by a method including polymerizing the polyfunctional monomer described above in a coating film of a coating containing the monomer and the black titanium compound on the substrate layer to fabricate the surface layer on the substrate layer.

The coating described above is a liquid composition containing the monomer, a polymerization initiator, and the materials of the surface layer. The materials include the black titanium oxide and other components aforementioned.

One or more of such polymerization initiators described above may be used. From the viewpoint of the polymerization (curing) efficiency of the monomer, that the polymerization initiator is a polymerization initiator having an acylphosphine oxide skeleton (acylphosphine oxide polymerization initiator) or a filling initiator having an oxime-ester skeleton (an oxime-ester polymerization initiator) is preferred, from the viewpoint of improving the reaction ratio of the polymerization reaction in the coating in polymerizing the monomer by irradiation of ultraviolet radiation. Any of the initiators can be commercially available, and examples of the former include IRGACURE TPO and IRGACURE 819 (both manufactured by BASF SE), and examples of the latter include IRGACURE OXE 02 and IRGACURE OXE 01 (both manufactured by BASF SE).

The black titanium compound relatively weakly absorbs light having a wavelength of 350 to 450 nm, particularly a wavelength of 400 to 450 nm. Accordingly, for polymerization of the monomer by means of the high-energy light beam, it is preferred that a beam source having a main light emission at a wavelength of 350 to 450 nm be used and, as the polymerization initiator, a highly sensitive polymerization initiator having an oxime ester skeleton (the above-described OXE02, OXE01, and the like) be selected. The main light emission of the beam source more preferably has a wavelength of 360 to 410 nm.

More specifically, the polymerization initiator is preferably an oxime ester polymerization initiator (e.g., the above-described OXE01, OXE02 and the like), more preferably a carbazole-skeleton-containing oxime ester polymerization initiator (e.g., OXE02) from the viewpoint of achieving a reaction at a high polymerization reaction ratio even in an acryl monomer coating containing a deep colorant. Alternatively, from the viewpoint of the versatility, the entire light absorption in the ultraviolet region and wavelength regions around the ultraviolet region, and particularly, the radical formation ability under light at a wavelength of 405 nm, and the viewpoint of relatively less degradation of the polymerization initiator caused by oxygen inhibition among acylphosphine oxide polymerization initiators and the suitability for curing thin films, monoacylphosphine oxide polymerization initiators (e.g., the above-described IRGACURE TPO and the like) are preferred.

The coating may contain further components advantageous for formation of the coating film and the polymerization described above. Examples of such further components include organic solvents, reaction accelerators, and monofunctional monomers.

One or more of the organic solvents may be used, and examples thereof include methyl ethyl ketone, methyl isopropyl ketone, methyl isobutyl ketone, methyl isoamyl ketone, methyl n-butyl ketone, diethyl ketone, cyclopentanone, cyclohexanone, ethyl acetate, isopropyl acetate, isobutyl acetate, isoamyl acetate, toluene, xylene, propylene glycol monomethyl ether, ethylene glycol monomethyl ether, and tetrahydrofuran.

The method for polymerizing the monomers may be polymerization by heating or may be polymerization by irradiation with a high energy light beam. The high energy light beam is a beam that provides energy for polymerizing the monomers, and examples thereof include electron beams and ultraviolet radiation. In polymerization by heating, thermal modification of the black titanium compound may occur, or expansion and contraction of the surface layer caused by temperature changes may lead to deterioration of the surface layer. From the viewpoint of suppressing these, polymerization of the monomers is preferably carried out by irradiating the coating film with the high energy light beam.

The polymerization initiator can be selected appropriately in accordance with the method for polymerizing the monomers. Since the black titanium compound has low transmittance of light having a wavelength particularly of less than 350 nm, the beam source for curing is preferably an apparatus that emits a beam having a main light emission at a wavelength of 350 to 450 nm, and the polymerization initiator is preferably selected in accordance with the beam source.

The reaction accelerator described above is added to the coating in order to improve the reaction ratio in the polymerization of monomers by ultraviolet radiation One or more of such reaction accelerators may be used, and from the viewpoint of achieving a reaction accelerating effect with a small amount thereof and the viewpoint of suppressing inhibition of the polymerization by oxygen, the reaction accelerator is preferably an aromatic tertiary amine compound. Examples thereof include KAYACURE EPA (manufactured by NIPPON KAYAKU Co., Ltd., “KAYACURE” is a registered trademark of the company).

The monofunctional monomer described above can be added to the coating for the purpose of adjusting the physical properties of the coating (e.g., viscosity and the like). The monofunctional monomer may be a monomer that exhibits the same polymerization reaction as for the polyfunctional monomer, for example, a monofunctional (meth)acrylate. Examples thereof include butyl (meth)acylate, isoamyl (meth)acylate, tert-butyl (meth)acylate, ethylhexyl (meth)acylate, and isobutyl (meth)acylate.

In the production method described above, the surface layer is preferably fabricated under an environment of 200° C. or less and is more preferably fabricated under an environment of 180° C. or less from the viewpoint of suppressing the modification of the black titanium compound because the black titanium compound is oxidized and changed into a normal titanium oxide (a tetravalent oxide of titanium) under a high-temperature environment.

With the change of a black titanium compound into a white titanium oxide caused by a high-temperature environment, the high hydrophilicity of the white titanium oxide, in the surface layer, may cause a fracture of the interface between the white titanium oxide, which was originally a black titanium compound, and a polymer of the monomers to proceed to thereby make the durability and electrical properties under a high temperature and high humidity environment insufficient. The change described above, which is an irreversible change, can be detected by an analysis method that can distinguish a white titanium oxide from a black titanium compound.

Unfortunately, the change does not substantially occur in a short period of about a few minutes, although depending on the temperature. Leaving the compound under an environment having a temperature of around 200° C. for a long period, or subjecting the compound to an environment having a sufficiently high temperature of 300° C. or more may lead to a decline in the properties described above. Accordingly, the production method described above may include a production environment of 200° C. or more, in the range where the effect of the present embodiment can be achieved.

In the polymerization reaction of the monomers, it is preferred that inhibition of the polymerization reaction by oxygen be suppressed. For example, it is preferred to add an aromatic tertiary amine having a specific structure to the coating. The aromatic tertiary amine is an aromatic tertiary amine having a structure in which hydrogen atoms are bonded to a carbon atom adjacent to the nitrogen atom, and an example thereof is ethyl 4-(dimethylamino)benzoate. It is preferred that the coating contain the aromatic tertiary amine, in order for restoring the radical in the monomers deactivated by oxygen inhibition, from the viewpoint of improving the reaction ratio of the polymerization reaction, and from the viewpoint of lowering the adverse effect caused by oxygen inhibition.

In irradiating the coating film with a high energy light beam, the oxygen concentration in the atmosphere for the coating film is preferably lowered to 5,000 ppm or less, for example. Such a decrease in the oxygen concentration in the atmosphere can be carried out by replacing the atmosphere with nitrogen gas.

The production method described above may further include other steps other than fabricating the surface layer in the range where the effect of the present embodiment can be achieved. Examples of such other steps include fabricating the substrate layer in advance of fabrication of the surface layer and improving the adhesion of the surface of the substrate layer that is to be an interface with the surface layer. The fabricating the substrate layer can be carried out by a known method as aforementioned.

The improving the adhesion described above can be appropriately selected from known methods depending on the type of the resin constituting the substrate layer, and, for example, may be irradiating the surface of the substrate layer with ultraviolet irradiation (UV irradiation) or bringing ozone into contact with the surface (ozone treatment) or irradiating the surface with corona discharge (corona treatment).

The intermediate transfer member can be used as the intermediate transfer member in an electrophotographic image forming apparatus. The image forming apparatus can be constituted and can be used for formation of an image in the same manner as a known image forming apparatus, except that the intermediate transfer member of the present embodiment described above is used as the intermediate transfer member.

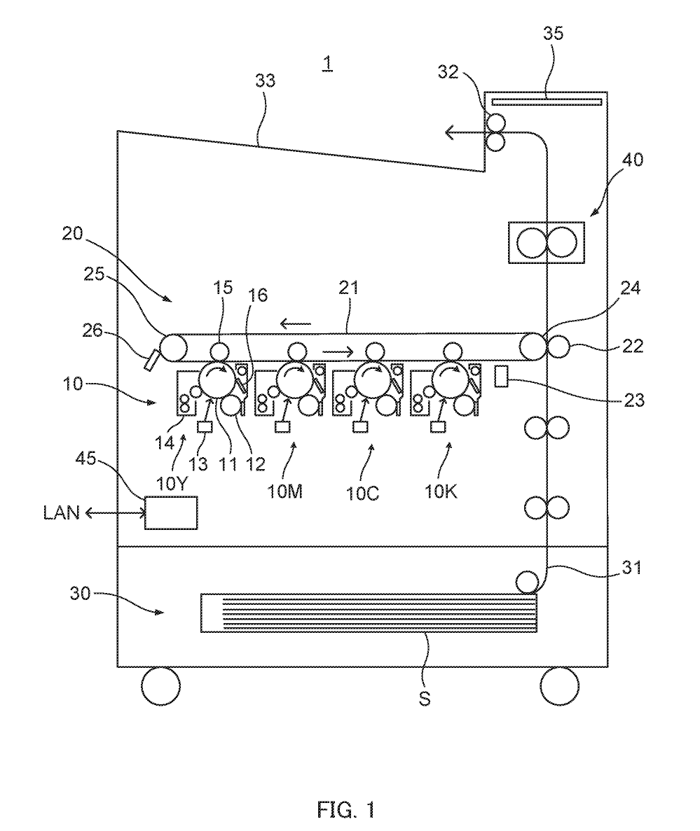

Hereinafter, the image forming apparatus of one embodiment of the present invention will be described based on FIG. 1. FIG. 1 schematically illustrates one exemplary configuration of the image forming apparatus of the present embodiment. Image forming apparatus 1 has image process section 10, transfer section 20, paper feed section 30, fixing section 40, and control section 45, as shown in FIG. 1.

Image process section 10 has imaging sections 10Y, 10M, 10C, and 10K corresponding to developing colors: yellow (Y), magenta (M), cyan (C), and black (K), respectively. Imaging section 10Y has photoconductor drum 11 as an electrostatic latent image carrier, charger 12 that charges the surface of photoconductor drum 11, exposing device 13 that forms an electrostatic latent image on the surface of photoconductor drum 11 that has been charged, developing section 14 that supplies toner particles to the surface of photoconductor drum 11 on which the electrostatic latent image has been formed to thereby develop the electrostatic latent image, primary transfer roller 15 that transfers the toner image formed from the surface of photoconductor drum 11 onto the intermediate transfer member, and cleaner 16 that removes toner particles remaining on the surface of photoconductor drum 11 from the surface. In FIG. 1, the signs of the constituents of other imaging sections 10M, 10C, and 10K are omitted, but as shown in FIG. 1, these imaging sections have constituents similar to those of imaging section 10Y.

Charger 12 is a contact charging device that charges photoconductor drum 11 by coming in contact with the drum, for example. Exposing device 13 is a device that emits laser light in accordance with an image to be formed, for example. Developing section 14 is a developing device for two-component developer. Cleaner 16 is a rubber elastic blade, for example.

Transfer section 20 has intermediate transfer member 21 as an endless belt that is disposed to include primary transfer roller 15 in its endless track, driving roller 24 and driven roller 25 by which intermediate transfer member 21 is stretched, density detecting sensor 23 that detects the image density of the toner image primary transferred onto intermediate transfer member 21, secondary transfer roller 22 that is disposed to face driving roller 24 via intermediate transfer member 21, and cleaning blade 26 that abuts on the surface of intermediate transfer member 21 stretched by driven roller 25 to thereby remove toner particles remaining on the surface.

Intermediate transfer member 21, which is a seamless belt (endless belt), is fabricated by injection molding or centrifugal molding a resin material so as to have a desired circumference specified by design. Intermediate transfer member 21 corresponds to the intermediate transfer member in the present embodiment. Density detecting sensor 23 is a reflective photoelectric sensor, for example. Cleaning blade 26 is a rubber elastic blade, for example.

Paper feed section 30 has conveyance path 31 that conveys sheets S accommodated as recording media in a sheet feeding cassette to secondary transfer roller 22 and fixing section 40, sheet ejection roller 32 that ejects sheet S after fixing out of image forming apparatus 1, and sheet tray 33 that accommodates sheets S ejected out of the apparatus.

Fixing section 40 has a heating member and a pressing member that heat and press an unfixed toner image carried on the surface of sheet S onto the surface of sheet S by secondary transfer.

Control section 45 is connected via a network (e.g., a LAN) to an external terminal (not shown) Image forming apparatus 1 also has operation panel 35.

In image forming apparatus 1, control section 45 selects to print in color or in monochrome based on the print job received from the external terminal or received from operation panel 35.

Photoconductor drum 11 rotates in the direction shown by the arrow, and charger 12 charges the circumferential surface of photoconductor drum 11. Exposing device 13 light exposure-scans photoconductor drum 11 charged using laser light to form an electrostatic latent image on photoconductor drum 11. Developing section 14 accommodates a two-component developer containing toner particles therein and develops the electrostatic latent image on photoconductor drum 11 with the toner particles. This development allows a yellow toner image to be formed in imaging section 10Y onto photoconductor drum 11, for example, to thereby allow photoconductor drum 11 to carry the toner image.

Intermediate transfer member 21 runs in the arrow direction in a circulating manner while stretched by driving roller 24 and driven roller 25. The yellow toner image on photoconductor drum 11 is transferred onto intermediate transfer member 21 by an electrostatic action of primary transfer roller 15. In this manner, the toner image is primary transferred onto intermediate transfer member 21. Residual toner remaining on photoconductor drum 11 after primary transfer is removed from photoconductor drum 11 by cleaner 16. The image density of the toner image formed on intermediate transfer member 21 is detected by density detecting sensor 23.

In case of printing in color, each in imaging sections 10M, 10C, and 10K, a toner image in the corresponding color is imaged on photoconductor drum 11, and the toner image imaged of each color is transferred onto intermediate transfer member 21. The imaging operations for the respective colors are carried out from the upstream to the downstream in the moving direction of intermediate transfer member 21 with timing shifted such that the toner images of the different colors are transferred in a superposed manner onto the same position of intermediate transfer member 21 that is running.

Meanwhile, paper feed section 30 delivers one sheet S at a time from the sheet feeding cassette in accordance with the imaging timing and conveys sheet S on conveyance path 31 toward secondary transfer roller 22. When sheet S conveyed to secondary transfer roller 22 passes between secondary transfer roller 22 and intermediate transfer member 21, the toner image formed on intermediate transfer member 21 is transferred entirely onto sheet S by an electrostatic action of secondary transfer roller 22. That is, the toner image is secondary transferred from intermediate transfer member 21 onto sheet S.

The toner particles remaining on intermediate transfer member 21 after secondary transfer are removed from intermediate transfer member 21 by cleaning blade 26.

Sheet S carrying the toner image secondary transferred is conveyed to fixing section 40 and heated and pressed in fixing section 40 to thereby melt and fix the toner particles on the surface of sheet S onto the surface. The toner image unfixed is thus fixed onto sheet S. Sheet S having the toner image fixed is ejected on sheet tray 33 by sheet ejection roller 32. In this manner, the desired toner image is formed on sheet S.

In case of printing in monochrome, for example, in black, a desired black toner image is formed on sheet S by the same operations described above except that only imaging section 10K is driven.

Image forming apparatus 1, because of having intermediate transfer member 21, can form high quality images in which image defects caused by transfer defects are prevented over a long period. The reason will be described hereinafter.

Intermediate transfer member 21, as aforementioned, contains a black titanium compound in the filler dispersed in the integrated surface layer made of an acrylic resin. Tetravalent titanium atoms are stable than those having other valence. The black titanium compound contains components of trivalent titanium or lower order titanium oxide.

When the titanium atoms are focused on, both trivalent titanium and oxygen-deficient titanium oxide (lower order titanium oxide) have a higher content of electrons contributing to conductivity than that of TiO₂. Accordingly, black titanium compound powder exhibits lower electrical resistance than that of TiO₂.

The content ratio of oxygen atoms both in a trivalent titanium oxide and in a lower order titanium oxide is lower than that of tetravalent fillers such as SnO₂ and TiO₂. Thus, the hydrophilicity of the black titanium compound described above is lower than that of the tetravalent fillers described above and becomes unlikely to be influenced by water. Since having a low content of oxygen atoms, the black titanium compound has a lower polarity than that of a usual inorganic oxide (tetravalent filler). Thus, the black titanium compound is unlikely to aggregate and cluster, and is suitable for homogeneous dispersion into the surface layer. Furthermore, the black titanium compound, unlike TiO₂, has no photocatalytic property. Accordingly, development of a photocatalytic function causes no change or deterioration in the electrical properties.

As aforementioned, the black titanium compound, which has lower resistance as powder and a lower hydrophilicity in comparison with TiO₂ and is more unlikely to cluster in dispersion into a coating for surface layer, causes no change or deterioration in the electrical properties of the surface layer after the intermediate transfer member is formed. Dispersion of the black titanium compound as the filler in the surface layer thus enables fine and homogeneous conductive paths in the surface layer to be formed independently of variations in the environment in electrophotographic image formation. For this reason, in the intermediate transfer member, in comparison with a conventional surface layer, which principally contains a tetravalent filler, the volume resistivity of the surface layer is slightly lower, and variations in the volume resistance in the surface direction decrease.

In addition, the black titanium compound has good dispersibility. For this reason, when the black titanium compound is contained in the surface layer at a blend ratio up to which particles of the black titanium compound do not come into contact with each other (e.g., 40 vol % or less of the surface layer), the electrical resistance of the surface layer can be made higher than the electrical resistance of the black titanium compound in the powder form, and the electrical resistance of the surface of the surface layer can be made larger. As a result, when a transfer current is applied to the intermediate transfer member, a small amount of charges remains inside the intermediate transfer member and cross flowing of the current can be prevented. It is thus conceived that images having satisfactory image quality independently of the environment can be formed over a long period.

Herein, “cross flowing” will be described. When a potential difference is applied between one point on the surface of the intermediate transfer member and one point on the back face thereof, the potential difference is usually applied over the shortest distance between the surface and the back face, and the electricity passes over the shortest distance. However, when there is a section having locally large electrical resistance on the shortest route connecting the point on the surface to the point on the back face, the electricity passes via a point deviating the shortest route described above. As a result, the electricity passes across the direction along the surface direction of the intermediate transfer member to an unintended position at a distance deviating the shortest route described above. This is referred to as the “cross flowing” of a current.

For the reason described hereinabove, image forming apparatus 1 having intermediate transfer member 21 can form high quality images in which image defects caused by transfer defects are prevented over a long period irrespective of the image formation environment.

Use of the black titanium compound having the features described above in combination with a resin obtained from polymerization of polyfunctional monomers having UV curing ability in the surface layer of intermediate transfer member 21 prevents movement, that is, migration of the filler in association with long-term image formation to thereby provide an effect of improving the durability, in addition to the effect of improving the image quality aforementioned.

The black titanium compound strongly absorbs not only visible light but also near-infrared light. Thus, when an optical sensor having sensitivity to visible to near-infrared light (wavelength of 600 to 1,000 nm) is used as density detecting sensor 23 to measure the toner density on intermediate transfer member 21, the influence of reflected light on the surface of the substrate layer decreases and the detection by the optical sensor is stabilized.

Introduction of functional groups having reactivity to the polymerization aforementioned onto the surface of the black titanium compound leads to formation of a crosslinked structure between the resin forming the surface layer and the titanium oxide compound. The film strength of the surface layer is thus further improved, and additionally, migration of the black titanium compound is prevented to thereby enable the electrical resistance property of the surface layer to be maintained over a longer period. Accordingly, use of the surface-treated black titanium compound as described above is useful for maintaining both the mechanical properties and the electrical properties over a long period.

A further improvement in the dispersibility into the monomers by the surface treatment described above leads to a further improvement in the dispersibility into the resin described above of the surface layer. Thus, the contact between the black titanium compound particles in the surface layer diminishes to the utmost limit (substantially eliminates) For this reason, the use of the black titanium compound is effective from the viewpoint of preventing image deterioration caused by prevention of decrease in the surface resistance or by local unusual electric field concentration.

The black titanium compound, which absorbs visible light, generally exhibits a black color, and, as aforementioned, has some light transmission properties at a wavelength of 350 to 450 mm Thus, polymerization of the surface layer is carried out by means of irradiation of ultraviolet radiation enables the polymerization reaction (curing reaction) of the monomers to proceed suitably. Use of polyfunctional (meth)acrylate as the monomers described above as a raw material enables a surface layer having a three-dimensional crosslinked structure to be formed and is effective from the viewpoint of providing an effect of improving the durability.

The black titanium compound causes no modification such as compositional change and deterioration usually at normal temperature. However, as aforementioned, for example, at 200° C. or more, oxidation of titanium becomes likely to proceed. Depending on the temperature and the elapsed time, the black titanium compound changes to TiO₂ in the end, even in a common air atmosphere, and its electrical properties changes. Accordingly, in the surface layer having a structure requiring a process temperature more than 200° C. in production of the surface layer (thermosetting resin such as PI), the effects obtained by the present embodiment may be limited. This is because TiO₂ has a less oxygen deficiency and a lower electrical conductivity than those of the black titanium compound and the black titanium compound becomes hydrophilic by changing into TiO₂ to become susceptible to the moisture outside.

Then, coating, drying, and curing in accordance to production of the surface layer are all preferably carried out at a temperature less than 200° C. In order to avoid such a high-temperature environment in fabricating the surface layer, monomer polymerization (UV curing) by means of irradiation of ultraviolet radiation is desired.

As clear from the above description, the intermediate transfer member of the present embodiment has a substrate layer made of a resin and a surface layer disposed on the substrate layer. The surface layer is an integrated matter made of a polymer of a polyfunctional monomer and contains a black titanium compound dispersed in the surface layer and at least one component selected from the group consisting of oxime ester polymerization initiators, acylphosphine oxide polymerization initiators, and residues of these polymerization initiators. The intermediate transfer member thus can form high quality images electrophotographically over a long period irrespective of the environment.

That the black titanium compound contains one or both of a trivalent titanium and a lower order titanium oxide is further effective from the viewpoint of improving the stability of the black titanium compound.

That the black titanium compound has one or both of a (meth)acryloyl group and a residue thereof on its surface is further effective from the viewpoint of suppressing migration of the black titanium compound in the surface layer.

That the black titanium compound has no nitrogen atom is further effective from the viewpoint of improving the polymerization reaction ratio of the polyfunctional monomers and from the viewpoint of suppressing degradation in the performance of the intermediate transfer member over time.

That the content of the black titanium compound in the surface layer is 2 to 90 parts by volume based on 100 parts by volume of the inorganic material in the surface layer is more effective from the viewpoint of developing the effect by the black titanium compound and of achieving sufficient polymerization (curing) of the resin constituting the surface layer, and that the content is 5 to 60 parts by volume is further effective from the viewpoints described above.

That the resin of the substrate layer is polyimide, polyphenylenesulfide, or polyamideimide is still further effective from the viewpoint of improving the mechanical strength of the substrate layer and from the viewpoint of improving the durability of the intermediate transfer member.

That the thickness of the surface layer is 0.8 to 10 μm is still further effective from the viewpoint of improving the durability of the surface layer and from the viewpoint of suppressing generation of the unreacted polyfunctional monomers in the polymerization reaction.

More specifically, when the thickness falls below 0.8 μm, the reaction ratio becomes likely to be insufficient because of oxygen inhibition, and thus, unreacted functional groups derived from the monomers remain. For this reason, degradation in the properties may become likely to occur in the case of continuous endurance in the image forming apparatus. When the thickness exceeds 10 μm, oxygen inhibition poses particularly no problem, but a problem of an insufficient reaction ratio due to an excessive extinction coefficient may occur, and similar degradation in the properties may become likely to occur. From the viewpoint of suppressing degradation in the properties caused by a decrease in the reaction ratio of the monomers, a thickness of the surface layer of 0.8 to 10 μm is further effective.

The method for producing an intermediate transfer member described above includes polymerizing the polyfunctional monomer described above in a coating film of a coating containing the monomer and the black titanium compound on the substrate layer made of the resin to fabricate the surface layer on the substrate layer, wherein the coating contains one or both of an oxime ester polymerization initiator and an acylphosphine oxide polymerization initiator, and the coating film is irradiated with a high energy light beam that provides energy for polymerizing the monomer to thereby polymerize the monomer. Accordingly, there can be provided an intermediate transfer member that can form high quality images electrophotographically over a long period irrespective of the environment.

In the production method, fabricating the surface layer under an environment of 200° C. or less is further effective from the viewpoint of suppressing the modification of the black titanium compound.

The image forming apparatus has the intermediate transfer member. Accordingly, the image forming apparatus can form high quality images electrophotographically over a long period irrespective of the environment.

As aforementioned, in fabrication of the surface layer, the intermediate transfer member can develop an effect on the synergistic load of mechanical endurance and energization endurance by use of a polymerization initiator suitable with respect to various conditions such as the reactivity, extinction coefficient, and wavelength range of the light absorbed by the black titanium compound of the polymerization initiator, in addition to use of the black titanium compound, and by use of other materials suitable with respect to the conditions described above as required in combination.

### EXAMPLES

Hereinafter, the present invention will be described specifically by way of examples, but the present invention is not construed to be limited by these examples.

[Fabrication of Substrate Layer 1]

Placed in single-screw extruder and melt-kneaded were 100 parts by volume of a polyphenylenesulfide resin (“E2180”, manufactured by Toray, Industries, Inc.), 16 parts by volume of a conductive filler (“Carbon black #3030B” manufactured by Mitsubishi Chemical Corporation), 1 part by volume of a graft copolymer (“MODIPER (registered trademark) A4400”, manufactured by NOF CORPORATION), and 0.2 parts by volume of a slip agent (calcium montanate) to obtain a resin mixture.

Subsequently, the resin mixture obtained was placed in a single screw extruder having an annular die at its tip having a slit-type extrusion outlet in a seamless belt form to extrude the mixture into a seamless belt form. Then, the resin mixture extruded in the seamless belt form was placed into a cooling cylinder provided at the extrusion outlet to be cooled to solidification. Thus fabricated was a seamless cylindrical (endless belt type) substrate layer 1 made of PPS having a thickness of 120 μm, a circumference of 750 mm, and a width of 359 mm.

[Fabrication of Substrate Layer 2]

To a N-methyl-2-pyrrolidone (NMP) solution of a polyamic acid made of 3,3′,4,4′-biphenyltetracarboxylic dianhydride (BPDA) and p-phenylenediamine (PDA) (“U-Varnish S”, manufactured by Ube Industries, Ltd., solid content 18 mass %), dry oxidized carbon black (“SPECIALBLACK 4”, manufactured by Degussa AG pH 3.0, volatile content: 14.0%) was added to achieve a content of 23 parts by mass based on 100 parts by mass of a polyimide resin solid content. The mixture obtained was divided into two portions, and then, the two portions were mixed by allowing the portions to collide with each other using a collision type dispersing apparatus “Geanus PY” (manufactured by Geanus Co.) at a pressure of 200 MPa and a minimum area of 1.4 mm². These division and mixing were repeated further six times to obtain a polyamic acid solution containing carbon black.

The polyamic acid solution containing carbon black obtained was coated at a thickness of 0.5 mm onto the inner peripheral surface of a cylindrical mold via a dispenser, and the mold was rotated at 1,500 rpm for 15 minutes to fabricate a developed layer of the solution described above having a uniform thickness. Additionally, hot air at 60° C. was applied to the outside of the mold for 30 minutes while the mold was rotated at 250 rpm, and then the mold was heated at 150° C. for 60 minutes. Subsequently, the temperature was raised at a temperature rising rate of 2° C./minute to 360° C., and the mold was additionally heated at 360° C. for 30 minutes to carry out removal of the solvent, ring closure by dehydrogenation, removal of water generated at the time, and completion of imide conversion. Thereafter, the mold was cooled to room temperature, and the resin belt formed was removed from the inner peripheral surface of the mold. Thus, endless belt type substrate layer 2 made of PI having a thickness of 100 μm, a circumference of 750 mm, and a width of 359 mm was fabricated as above described.

[Fabrication of Substrate Layer 3]

Mixed were 963.86 g of a polyamideimide varnish (“VYLOMAX (registered trademark) HR-11NN”, manufactured by TOYOBO CO., LTD.) and 36.145 g of a carbon nanofiber dispersion liquid (“AMC (registered trademark)”, manufactured by Ube Industries, Ltd.). The mixture was divided in portions, and the portions were defoamed in a planetary centrifugal mixer (“AR-250”, manufactured by THINKY CORPORATION) to prepare a coating solution. The solvent of the polyamideimide varnish is NMP, the weight average molecular weight of the polyamideimide resin contained is 72,000, and the number average molecular weight of the polyamideimide resin is 19,000. The concentration of the dispersoid in the carbon nanofiber dispersion liquid (carbon nanofiber) is 5.0 mass %, the dispersion medium is NMP, and the average particle size of the carbon nanofiber is 11 nm.

The coating solution obtained was coated onto the outer peripheral surface of a cylindrical mold via a dispenser, and the mold was rotated to provide a uniform coating film. Hot air at 60° C. was applied to the outside of the mold for 30 minutes, the mold was heated at 150° C. for 60 minutes, and then fired at 250° C. for 60 minutes. Thereafter, the mold was cooled at a rate of 2° C./minute to room temperature (25° C.), and the resin belt formed was removed from the mold. Thus, endless belt type substrate layer 3 made of PAI having a thickness of 80 μm, a circumference of 750 mm, and a width of 359 mm was fabricated as above described.

[Preparation of Black Titanium Compound 1]

Synthesis was carried out in accordance with the method described in the aforementioned NPL “Synthesis of Ti₄O₇ Nanoparticles by Carbothermal Reduction Using Microwave Rapid Heating (Catalysts 2017. 7, 65-)” to obtain a black titanium compound having a composition of Ti₄O₇ (average particle size 60 nm). The L value of the black titanium compound was measured by a chroma meter “CR-400” manufactured by Konica Minolta, Inc. to be 14.0.

Mixed were 100 parts by volume of the black titanium compound synthesized by the method described above, 12 parts by volume of 3-acryloxypropyltrimethoxysilane (“KBM-5103”, manufactured by Shin-Etsu Chemical Co., Ltd.), and 400 parts by volume of methanol. The mixture was dispersed using a wet media dispersion type apparatus for 45 minutes, methanol was removed, and then, the powder obtained was dried at 150° C. for 20 minutes. Black titanium compound 1 as a surface-treated black titanium compound was thus obtained. Black titanium compound 1 had an L value of 14.6.

[Preparation of Black Titanium Compound 2]

Titanium dioxide (number average particle size 100 nm) and Ti powder (number average particle size 100 nm) were mixed to achieve a molar ratio of 3:1 and heated in a vacuum of 10 to 2 torr at 800° C. for 15 hours to obtain particles of a lower order titanium oxide principally based on Ti₂O₃. These lower order titanium oxide particles had a BET value of 14.5 m³/g. The main component was identified using the X ray diffraction method. The lower order titanium oxide particles had an L value of 9.1.

Mixed were 100 parts by volume of the lower order titanium oxide particles described above, 11 parts by volume of 3-acryloxypropyltrimethoxysilane (“KBM-5103”, manufactured by Shin-Etsu Chemical Co., Ltd.), and 400 parts by volume of methanol. The mixture was dispersed using a wet media dispersion type apparatus for 45 minutes, methanol was removed, and then, the powder obtained was dried at 150° C. for 20 minutes. Black titanium compound 2 as a surface-treated black titanium compound was thus obtained. Black titanium compound 2 had an L value of 9.3.

[Preparation of Black Titanium Compound 3]

Mixed were 100 parts by volume of “Titanium Black 13M-T” (manufactured by Mitsubishi Materials Corporation, L value: 9.6), 10 parts by volume of 3-acryloxypropyltrimethoxysilane (“KBM-5103”, manufactured by Shin-Etsu Chemical Co., Ltd.), and 400 parts by volume of methanol. The mixture was dispersed using a wet media dispersion type apparatus for 45 minutes, methanol was removed, and then, the powder obtained was dried at 150° C. for 10 minutes. Black titanium compound 3 as a surface-treated black titanium compound was thus obtained. Black titanium compound 3 had an L value of 10.0.

[Preparation of Black Titanium Oxide Compound 4]

Titanium dioxide (number average particle size 100 nm) and Ti powder (number average particle size 100 nm) were mixed to achieve a molar ratio of 1:1 and heated in a vacuum of 10 to 2 torr at 900° C. for 30 hours to obtain particles of a lower order titanium oxide principally based on TiO. These lower order titanium oxide particles had a BET value of 16.7 m³/g. The main component was identified using the X ray diffraction method. The lower order titanium oxide particles had an L value of 20.7.

Mixed were 100 parts by volume of the lower order titanium oxide particles described above, 12 parts by volume of 3-acryloxypropyltrimethoxysilane (“KBM-5103”, manufactured by Shin-Etsu Chemical Co., Ltd.), and 400 parts by volume of methanol. The mixture was dispersed using a wet media dispersion type apparatus for 45 minutes, methanol was removed, and then, the powder obtained was dried at 150° C. for 20 minutes. Black titanium compound 4 as a surface-treated black titanium compound was thus obtained. Black titanium compound 4 had an L value of 21.8.

[Preparation of Tin Oxide 1]

Mixed was 100 parts by volume of tin oxide particles having an average particle size 30 nm, with 400 parts by volume of a mixed liquid prepared by mixing 16 parts by volume of 3-acryloxypropyltrimethoxysilane (KBM-5103; manufactured by Shin-Etsu Chemical Co., Ltd.), toluene, and methanol in the order mentioned in a volume ratio of 1:3. The mixture was dispersed using a wet media dispersion type apparatus for 45 minutes, the mixed liquid described above was removed, and then, the powder obtained was dried at 150° C. for 10 minutes. Tin oxide 1 as a surface-treated tin oxide was thus obtained.

[Preparation of Tin Oxide 2]

Tin oxide 2 as a surface-treated tin oxide was obtained in the same manner as in Preparation of tin oxide 1 except that the tin oxide particles having an average particle size of 30 nm were replaced by tin oxide particles having an average particle size of 50 nm.

[Preparation of ITO-1]

ITO-1 as a surface-treated ITO was obtained in the same manner as in Preparation of tin oxide 1 except that the tin oxide particles having an average particle size of 30 nm were replaced by indium tin oxide (ITO) particles having an average particle size of 30 nm.

[Preparation of White Titanium Oxide 1]

White titanium oxide 1 as a surface-treated white titanium oxide was obtained in the same manner as in Preparation of tin oxide 1 except that the tin oxide particles having an average particle size of 30 nm were replaced by “TTO-55” (manufactured by ISHIHARA SANGYO KAISHA, LTD., average particle size: 35 nm).

[Preparation of Coating Solution 1]

The following components in the amounts described below were dissolved and dispersed in MIBK (methyl isobutyl ketone) so as to achieve a solid content concentration of 10 mass %. Coating solution 1 for fabrication of surface layer was thus prepared.

| | | |
|---|---|---|
| Monomer 1 | 74.5 | parts by volume |
| Black titanium compound 1 | 1 | part by volume |
| Tin oxide 1 | 19 | parts by volume |
| Polymerization initiator | 4.3 | parts by volume |
| Additive | 1.2 | parts by volume |

Monomer 1, which is the compound represented by the following formula (1), corresponds to a polyfunctional monomer. The polymerization initiator is “IRGACURE OXE02” manufactured by BASF SE. The additive is “KAYACURE EPA” manufactured by NIPPON KAYAKU Co., Ltd. (“KAYACURE” is a registered trademark of the company).

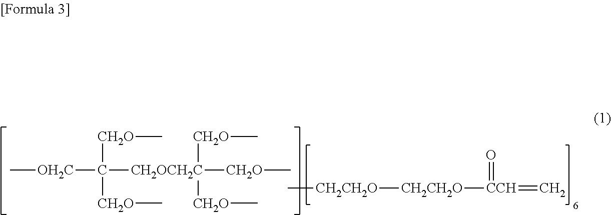

[Preparation of Coating Solutions 2 to 7]

Coating solutions 2, 3, 4, 5, and 6 were each prepared in the same manner as in Preparation of coating solution 1 except that the amount of black titanium compound 1 was changed to 2, 5, 8, 12, and 18 parts by volume and the amount of tin oxide 1 was changed to 18, 15, 12, 8, and 2 parts by volume, respectively. Coating solution 7 was prepared in the same manner as in Preparation of coating solution 1 except that the amount of black titanium compound 1 was changed to 20 parts by volume and no tin oxide 1 was added.

[Preparation of Coating Solution 8 and 9]

Coating solution 8 was prepared in the same manner as in Preparation of coating solution 1 except that the amount of black titanium compound 1 was changed to 10 parts by volume and tin oxide 1 was replaced by 10 parts by volume of tin oxide 2. Coating solution 9 was prepared in the same manner as in Preparation of coating solution 1 except that the amount of both black titanium compound 1 and tin oxide 1 were changed to 10 parts by volume and monomer 1 was replaced by monomer 2. Monomer 2 is “ethylene oxide-modified pentaerythritol tetraacrylate (a compound modified with two ethylene oxide groups on average per aciyloyl group)”. Monomer 2, which is the compound represented by the following formula (2), corresponds to a polyfunctional monomer. In the following formula (2), n is independently 2. n is an average value.

[Formula 4]

(CH₂═CHCO—(OC₂H₄)ₙ—O—CH₂₄C (2)

[Preparation of Coating Solutions 10 to 12]

Coating solution 10 was prepared in the same manner as in Preparation of coating solution 4 except that black titanium compound 1 was replaced by black titanium compound 2 and the polymerization initiator was replaced by “IRGACURE OXE01” (manufactured by BASF SE) as an oxime ester initiator. Coating solution 11 was prepared in the same manner as in Preparation of coating solution 4 except that black titanium compound 1 was replaced by black titanium compound 3 and the polymerization initiator was replaced by “IRGACURE TPO” (manufactured by BASF SE) as a monoacylphosphine oxide initiator. Coating solution 12 was prepared in the same manner as in Preparation of coating solution 4 except that black titanium compound 1 was replaced by black titanium compound 4 and the polymerization initiator was replaced by “IRGACURE 819” (manufactured by BASF SE) as an acylphosphine oxide initiator.

[Preparation of Coating Solution 13 and 14]

Coating solutions 13 and 14 were prepared in the same manner as in Preparation of coating solution 2 and Preparation of coating solution 4 respectively except that tin oxide 1 was replaced by white titanium oxide 1.

[Preparation of Coating Solutions 15 to 17]

Coating solution 15 was prepared in the same manner as in Preparation of coating solution 1 except that black titanium compound 1 was not added and tin oxide 1 was replaced by 20 parts by volume of ITO-1. Coating solution 16 was prepared in the same manner as in Preparation of coating solution 1 except that black titanium compound 1 was not added and tin oxide 1 was replaced by 20 parts by volume of white titanium oxide 1. Coating solution 17 was prepared in the same manner as in Preparation of coating solution 1 except that black titanium compound 1 was replaced by 10 parts by volume of white titanium oxide 1 and the amount of tin oxide 1 was changed to 10 parts by volume.

[Preparation of Coating Solution 18]

Coating solution 18 was prepared in the same manner as in Preparation of coating solution 1 except that the polymerization initiator was replaced by “IRGACURE 500” (manufactured by BASF SE). “IRGACURE 500” is a mixture of 1-hydroxy-cyclohexyl-phenyl ketone and benzophenone.

The compositions of coating solutions 1 to 18 are listed in Table 1. In Table 1, “OXE02” represents “IRGACURE OXE02”, “OXE01” represents “IRGACURE OXE01”, “TPO” represents “IRGACURE TPO”, “819” represents “IRGACURE 819”, and “500” represents “IRGACURE 500”.

TABLE 1

| | Black titanium | | | | Polyfunctional | | | | |
|---|---|---|---|---|---|---|---|---|---|
| | compound | | Other particles | | monomer | | | Polymerization | |
| Coating | | Amount | | Amount | | Amount | Polymerization | initiator | Additive |
| solution | | (parts by | | (parts by | | (parts by | initiator | (parts by | (parts by |
| No. | No. | volume) | Type | volume) | No. | volume) | (Type) | volume) | volume) |
| 1 | 1 | 1 | Tin oxide 1 | 19 | 1 | 74.5 | OXE02 | 4.3 | 1.2 |
| 2 | 1 | 2 | Tin oxide 1 | 18 | 1 | 74.5 | OXE02 | 4.3 | 1.2 |
| 3 | 1 | 5 | Tin oxide 1 | 15 | 1 | 74.5 | OXE02 | 4.3 | 1.2 |
| 4 | 1 | 8 | Tin oxide 1 | 12 | 1 | 74.5 | OXE02 | 4.3 | 1.2 |
| 5 | 1 | 12 | Tin oxide 1 | 8 | 1 | 74.5 | OXE02 | 4.3 | 1.2 |
| 6 | 1 | 18 | Tin oxide 1 | 2 | 1 | 74.5 | OXE02 | 4.3 | 1.2 |
| 7 | 1 | 20 | — | — | 1 | 74.5 | OXE02 | 4.3 | 1.2 |
| 8 | 1 | 10 | Tin oxide 2 | 10 | 1 | 74.5 | OXE02 | 4.3 | 1.2 |
| 9 | 1 | 10 | Tin oxide 1 | 10 | 2 | 74.5 | OXE02 | 4.3 | 1.2 |
| 10 | 2 | 8 | Tin oxide 1 | 12 | 1 | 74.5 | OXE01 | 4.3 | 1.2 |
| 11 | 3 | 8 | Tin oxide 1 | 12 | 1 | 74.5 | TPO | 4.3 | 1.2 |
| 12 | 4 | 8 | Tin oxide 1 | 12 | 1 | 74.5 | 819 | 4.3 | 1.2 |
| 13 | 1 | 2 | White titanium oxide 1 | 12 | 1 | 74.5 | OXE02 | 4.3 | 1.2 |
| 14 | 1 | 8 | White titanium oxide 1 | 12 | 1 | 74.5 | OXE02 | 4.3 | 1.2 |
| 15 | — | — | ITO-1 | 20 | 1 | 74.5 | OXE02 | 4.3 | 1.2 |
| 16 | — | — | White titanium oxide 1 | 20 | 1 | 74.5 | OXE02 | 4.3 | 1.2 |
| 17 | — | — | White titanium oxide 1 | 10 | 1 | 74.5 | OXE02 | 4.3 | 1.2 |
| | | | Tin oxide 1 | 10 | | | | | |
| 18 | 1 | 1 | Tin oxide 1 | 19 | 1 | 74.5 | 500 | 4.3 | 1.2 |

### Example 1

Coating solution 1 was coated onto the outer peripheral surface of substrate layer 1 using a coating apparatus by an immersion coating method (amount of coating solution (circulating) supplied: 1 L/minute) so as to achieve a thickness of 4.5 μm in dried state to thereby form a coating film. Subsequently, the coating film formed was dried by hot-air drying at 40° C. for five minutes, and then, the coating film was irradiated with ultraviolet radiation as actinic radiation (high energy light beam) under the following irradiation conditions to thereby radical polymerize the monomers in coating solution 1. In this manner, intermediate transfer member 1 having surface layer 1 constituted by an integrated matter produced by curing the coating film by the polymerization on substrate layer 1 was fabricated. Irradiation of ultraviolet irradiation was carried out with a light source fixed while the precursor having the coating film formed on the outer peripheral surface of the resin substrate layer was rotated at a peripheral velocity of 60 mm/second.

(Irradiation conditions of ultraviolet radiation)

Light source type: 365 nm LED light source (SPX-TA; EYE GRAPHICS CO., LTD.)

Distance from irradiation hole to coating film: 50 mm

Atmosphere: nitrogen (oxygen concentration 600 ppm or less)

Irradiation light quantity: 2.8 J/cm²

Irradiation time (rotation time of precursor): 240 seconds

### Examples 2 to 5

Intermediate transfer members 2 to 5 were fabricated in the same manner as in Example 1 except that coating solution 1 was replaced by coating solutions 2 to 5, respectively.

### Example 6

Intermediate transfer member 6 was fabricated in the same manner as in Example 1 except that coating solution 1 was replaced by coating solution 6 and the oxygen concentration in the atmosphere on ultraviolet irradiation was set to 100 ppm or less.

### Examples 7, 8, and 9

Intermediate transfer members 7, 8, and 9 were fabricated in the same manner as in Example 1 except that coating solution 1 was replaced by coating solutions 7, 8, and 9, respectively.

### Examples 10 and 11

Intermediate transfer members 10 and 11 were fabricated in the same manner as in Example 3 except that coating solution 3 was coated onto substrate layer 1 so as to achieve the thickness of 2.3 μm and 6.5 μm, respectively, in dried state.

### Examples 12 to 14

Intermediate transfer member 12 was fabricated in the same manner as in Example 3 except that substrate layer 1 was replaced by substrate layer 2. Intermediate transfer member 13 was fabricated in the same manner as in Example 12 except that coating solution 3 was replaced by coating solution 4. Intermediate transfer member 14 was fabricated in the same manner as in Example 3 except that substrate layer 1 was replaced by substrate layer 3.

### Examples 15 and 16

Intermediate transfer members 15 and 16 were fabricated in the same manner as in Example 3 except that the drying immediately after the coating of coating solution 3 was changed from hot air drying at 40° C. for five minutes to thermal drying at 180° C. for 30 minutes and to thermal drying at 220° C. for 30 minutes, respectively.

### Examples 17 to 19

Intermediate transfer members 17 to 19 were fabricated in the same manner as in Example 1 except that coating solution 1 was replaced by coating solutions 10 to 12, respectively.

### Examples 20 and 21

Intermediate transfer members 20 and 21 were fabricated in the same manner as in Example 1 except that coating solution 1 was replaced by coating solutions 13 and 14, respectively.

### Examples 22 and 23

Intermediate transfer members 22 and 23 were fabricated in the same manner as in Example 1 except that coating solution 1 was coated onto substrate layer 1 so as to achieve the thickness of 0.8 μm and 10 μm, respectively, in dried state.

### Comparative Examples 1 to 4

Intermediate transfer members 24 to 27 were fabricated in the same manner as in Example 1 except that coating solution 1 was replaced by coating solutions 15 to 18, respectively.

The structures of intermediate transfer members 1 to 27 are listed in Table 2.

TABLE 2

| | | Substrate layer | | | Surface layer | |
|---|---|---|---|---|---|---|
| | Intermediate | | | Thick- | Coating | Thick- |
| | transfer | | | ness | solution | ness |
| | member No. | No. | Material | (μm) | No. | (μm) |
| Example 1 | 1 | 1 | PPS | 120 | 1 | 4.5 |
| Example 2 | 2 | 1 | PPS | 120 | 2 | 4.5 |
| Example 3 | 3 | 1 | PPS | 120 | 3 | 4.5 |
| Example 4 | 4 | 1 | PPS | 120 | 4 | 4.5 |
| Example 5 | 5 | 1 | PPS | 120 | 5 | 4.5 |
| Example 6 | 6 | 1 | PPS | 120 | 6 | 4.5 |
| Example 7 | 7 | 1 | PPS | 120 | 7 | 4.5 |
| Example 8 | 8 | 1 | PPS | 120 | 8 | 4.5 |
| Example 9 | 9 | 1 | PPS | 120 | 9 | 4.5 |
| Example 10 | 10 | 1 | PPS | 120 | 3 | 2.3 |
| Example 11 | 11 | 1 | PPS | 120 | 3 | 6.5 |
| Example 12 | 12 | 2 | PI | 100 | 3 | 4.5 |
| Example 13 | 13 | 2 | PI | 100 | 4 | 4.5 |
| Example 14 | 14 | 3 | PAI | 80 | 3 | 4.5 |
| Example 15 | 15 | 2 | PI | 100 | 3 | 4.5 |
| Example 16 | 16 | 2 | PI | 100 | 3 | 4.5 |
| Example 17 | 17 | 1 | PPS | 120 | 10 | 4.5 |
| Example 18 | 18 | 1 | PPS | 120 | 11 | 4.5 |
| Example 19 | 19 | 1 | PPS | 120 | 12 | 4.5 |
| Example 20 | 20 | 1 | PPS | 120 | 13 | 4.5 |
| Example 21 | 21 | 1 | PPS | 120 | 14 | 4.5 |
| Example 22 | 22 | 1 | PPS | 120 | 1 | 0.8 |
| Example 23 | 23 | 1 | PPS | 120 | 1 | 10 |
| Comparative | 24 | 1 | PPS | 120 | 15 | 4.5 |
| Example 1 | | | | | | |
| Comparative | 25 | 1 | PPS | 120 | 16 | 4.5 |
| Example 2 | | | | | | |
| Comparative | 26 | 1 | PPS | 120 | 17 | 4.5 |
| Example 3 | | | | | | |
| Comparative | 27 | 1 | PPS | 120 | 18 | 4.5 |
| Example 4 | | | | | | |

[Provision of Image Forming Apparatus]

Intermediate transfer members 1 to 27 were each mounted instead of the genuine intermediate transfer member of an image forming apparatus “Bizhub C658” (manufactured by Konica Minolta Inc., “bizhub” is a registered trademark of the company) to provide Image forming apparatuses including each of intermediate transfer members 1 to 27.

[Evaluation]

### (1) Image Quality (Initial Stage)

First, intermediate transfer members 1 to 27 were each moisture-conditioned for 12 hours or more in each of the environments: normal temperature and normal humidity (NN) environment (20° C., 50% RH), low temperature and low humidity (LL) environment (10° C., 15% RH), and high temperature and high humidity (HH) environment (30° C., 85% RH). Subsequently, the image forming apparatuses described above including each of intermediate transfer members 1 to 22 described above were turned on and subjected to initialization and image stabilization in order to obtain optimal images by means of a combination of a new developing device filled with a new developer (a two-component developer made of new toner particles and new carrier particles), an intermediate transfer member for experiment, and a new photoconductor unit.

Then, a cyan solid image and a blue solid image were printed. As the recording media, A3-sized CF paper sheet manufactured by Konica Minolta, Inc. were used. The basis weight of the paper is 80 g/m³, but, for printing solid images described above, the paper type was registered at the equivalent of paperboard 3 in order to lower the printing speed to thereby emphasize image unevenness (to make the conditions stricter).

The image quality of the solid images of different colors was evaluated in accordance with the following criteria. Unevenness refers to an entire phenomenon derived from an inhomogeneous image density.

A No visual unevenness is noticed and the image quality is excellent.

B Visual unevenness is slightly noticed with careful observation, but the image quality is acceptable.

C Visual unevenness is noticed, and the image quality passes corresponds to the lowest acceptable level.

D Image unevenness can be seen any person, and the image quality is unacceptable.

E Image unevenness is severe, the concentration lacks homogeneity, and the image quality is out of the question.

(2) Image Quality (after Endurance)

The image forming apparatuses including each intermediate transfer members 1 to 27 were used to print A4 letter charts including 5% of each of YMCK colors (20% in total) in the continuous mode on 200,000 sheets in total, including 100,000 sheets in the NN environment, 50,000 sheets in the HH environment, and 50,000 sheets in the LL environment. Subsequently, while the photoconductor and the developing device were replaced by new ones and the intermediate transfer member used in the continuous printing was used as it was, a cyan solid image and a blue solid image were printed on each device by the method aforementioned, and their image quality was evaluated.

Evaluation results are shown in Table 3.

TABLE 3

| | Cyan image | | | | | | Blue image | | | | | |
|---|---|---|---|---|---|---|---|---|---|---|---|---|
| | Initial stage | | | After endurance | | | Initial stage | | | After endurance | | |
| | NN | LL | HH | NN | LL | HH | NN | LL | HH | NN | LL | HH |
| Example 1 | A | A | A | B | B | B | A | A | A | B | B | B |
| Example 2 | A | A | A | A | A | B | A | A | A | A | A | B |
| Example 3 | A | A | A | A | A | A | A | A | A | A | A | A |
| Example 4 | A | A | A | A | A | A | A | A | A | A | A | A |
| Example 5 | A | A | A | A | A | A | A | A | A | A | A | A |
| Example 6 | A | A | A | A | A | A | A | A | A | A | B | B |
| Example 7 | A | A | A | B | B | B | A | A | A | B | B | B |
| Example 8 | A | A | A | A | A | A | A | A | A | A | A | A |
| Example 9 | A | A | A | A | A | A | A | A | A | A | A | A |
| Example 10 | A | A | A | A | A | A | A | A | A | A | A | A |
| Example 11 | A | A | A | A | A | A | A | A | A | A | A | A |
| Example 12 | A | A | A | A | A | A | A | A | A | A | A | A |
| Example 13 | A | A | A | A | A | A | A | A | A | A | A | A |
| Example 14 | A | A | A | A | A | A | A | A | A | A | A | A |
| Example 15 | A | A | A | A | A | A | A | A | A | A | A | A |
| Example 16 | A | A | A | A | A | A | A | A | A | B | B | B |
| Example 17 | A | A | A | A | A | A | A | A | A | A | A | A |
| Example 18 | A | A | A | A | A | B | A | A | B | A | B | B |
| Example 19 | A | A | A | A | B | B | A | A | B | B | B | B |
| Example 20 | A | A | A | A | A | A | A | A | A | A | A | A |
| Example 21 | A | A | A | A | A | A | A | A | A | A | A | A |
| Example 22 | A | A | A | A | B | B | A | A | A | A | B | B |
| Example 23 | A | A | A | A | B | B | A | A | A | A | B | B |
| Comparative | A | A | A | C | D | D | A | A | A | D | E | E |
| Example 1 | | | | | | | | | | | | |
| Comparative | B | B | B | C | E | E | B | B | B | D | E | E |
| Example 2 | | | | | | | | | | | | |
| Comparative | A | A | A | C | C | D | A | B | B | D | D | D |
| Example 3 | | | | | | | | | | | | |
| Comparative | A | A | A | C | D | D | A | A | A | D | E | E |
| Example 4 | | | | | | | | | | | | |

As clear from Table 3, formation of an image by use of intermediate transfer members 1 to 23 provides sufficiently good image quality both in the initial stage and after endurance.

Particularly, with any of intermediate transfer members of Examples 3 to 5, 8 to 15, 17, 20, and 21, either in the initial stage or after endurance, and under any of the environments, both cyan and blue solid images having excellent image quality have been formed. It is believed that that this is because all the following conditions are satisfied.

First, the content of the black titanium compound in the surface layer exceeds the preferred lower limit, and thus, no local density unevenness caused by insufficient blending of the black titanium oxide compound occurs to thereby enable the homogeneity of the electrical resistance to be achieved. Accordingly, transfer current is applied homogeneously via endurance, no deterioration and change due to current concentration occur, and good images are formed irrespective of endurance.

Additionally, the content of the black titanium compound in the surface layer falls below the preferred upper limit, and thus, insufficient curing of the surface layer caused by excessive blending of the black titanium compound in in the curing reaction of the surface layer formation is prevented. For this reason, no composition deterioration as the surface layer occurs even after endurance, and, as a result, good images are formed after endurance. When the black titanium compound is excessively blended in the surface layer, the black titanium compound absorbs a larger amount of light that causes curing, and curing may not proceed in accordance with a decrease in light to be provided for curing of the surface layer by the polymerization initiator.

Furthermore, since the curing reaction process is carried out at 200° C. or less, no deterioration of the black titanium compound in association with the curing reaction occurs, and the effect from the black titanium compound is maximally exerted.

Also, a polymerization initiator suitable for improving the reaction ratio has been selected. Thus, a smaller amount of unreacted acryloyl groups remains, and the remaining unreacted acryloyl groups are not oxidized and degraded by the influence of energization and printing. As a result, even when endurance by the image forming apparatus is carried out, it is determined that a good result has been obtained.

Meanwhile, the intermediate transfer members of Comparative Examples 1 to 4 provides severe image unevenness after endurance and are far from the acceptable level.

In Comparative Example 1, in which the ITO is used as the conductive material in the surface layer, the electrical properties in the initial stage is good, but the hardness, durability, and chemical stability as a material are not sufficient. For this reason, in Comparative Example 1, it is conceived that the electrical conductivity and transfer property are altered and the image quality becomes insufficient after endurance.

In Comparative Example 2, in which the white titanium oxide is used as the conductive material in the surface layer, the electrical conductivity is insufficient. For this reason, in Comparative Example 2, it is conceived that electric field concentration continued in the portion having an excellent electric conductivity in the surface layer because of continuous formation of images, as a result, deterioration of the resin proceeded in the portion, and the image quality decreased because further lowering in the resistance proceeded.

In Comparative Example 3, in which the white titanium oxide and tin oxide are used in combination, the electrical conductivity of the surface layer is higher than that of Comparative Example 2, but more insufficient than that of each of Examples. Particularly, in the portion where a larger amount of the white titanium oxide is contained, the electrical conductivity is likely to be lacking. For this reason, in Comparative Example 3, it is conceived that continuous formation of images causes deterioration of the resin in the portion having excellent electric conductivity as in Comparative Example 2 to thereby lower the image quality.

In Comparative Example 4, for which the polymerization initiator was not suitably selected, the monomer reaction completed insufficiently. As a result of a large amount of remaining unreacted monomers, the properties in the initial stage are acceptable. It is conceived that, however, the image quality was lowered when both mechanical endurance and energization endurance were carried out in the image forming apparatus.

### INDUSTRIAL APPLICABILITY

According to the present invention, high quality images in which occurrence of image defects in association with transfer defects is suppressed can be formed electrophotographically over a long period irrespective of the image formation environment. According to the present invention, further proliferation of the image forming apparatus is promising.

Although embodiments of the present invention have been described and illustrated in detail, it is clearly understood that the same is by way of illustration and example only and not limitation, the scope of the present invention should be interpreted by terms of the appended claims.

What is claimed is:

1. An intermediate transfer member comprising a substrate layer made of a resin, and a surface layer disposed on the substrate layer, wherein
the surface layer is an integrated matter made of a polymer of a polyfunctional monomer and comprises a black titanium compound dispersed in the surface layer and at least one component selected from the group consisting of an oxime ester polymerization initiator, an acylphosphine oxide polymerization initiator, and residues of these polymerization initiators.

2. The intermediate transfer member according to claim 1, wherein the black titanium compound comprises one or both of a trivalent titanium and a lower order titanium oxide.

3. The intermediate transfer member according to claim 1, wherein the black titanium compound has one or both of a (meth)acryloyl group and a residue thereof on its surface.

4. The intermediate transfer member according to claim 1, wherein the black titanium compound comprises no nitrogen atom.

5. The intermediate transfer member according to claim 1, wherein the content of the black titanium compound in the surface layer is 2 to 90 parts by volume based on 100 parts by volume of inorganic material in the surface layer.

6. The intermediate transfer member according to claim 5, wherein the content of the black titanium compound in the surface layer is 5 to 60 parts by volume based on 100 parts by volume of inorganic material in the surface layer.

7. The intermediate transfer member according to claim 1, wherein the resin of the substrate layer is polyimide, polyphenylenesulfide, or polyamideimide.

8. The intermediate transfer member according to claim 1, wherein the surface layer has a thickness of 0.8 to 10 μm.

9. A method for producing the intermediate transfer member according to claim 1, comprising
polymerizing the polyfunctional monomer in a coating film of a coating containing the monomer and the black titanium compound on the substrate layer made of the resin to fabricate the surface layer on the substrate layer,
wherein the coating comprises one or both of an oxime ester polymerization initiator and an acylphosphine oxide polymerization initiator, and
the coating film is irradiated with a high energy light beam that provides energy for polymerizing the monomer to thereby polymerize the monomer.

10. The method for producing an intermediate transfer member according to claim 9, wherein the surface layer is fabricated under an environment of 200° C. or less.

11. An electrophotographic image forming apparatus comprising the intermediate transfer member according to claim 1.
